(19) United States
(12) Patent Application Publication
(10) Pub. No.: US 2005/0150726 A1
(43) Pub. Date: Jul. 14, 2005

(54) Coiled hose point of sale method and apparatus

(75) Inventors: David Weck, Miami, FL (US); Steven Berenson, Miami, FL (US)

Correspondence Address: LOWE HAUPTMAN GILMAN AND BERNER, LLP, 1700 DIAGONAL ROAD, SUITE 300 /310, ALEXANDRIA, VA, 22314, US

(73) Assignee: Micasa Trading Corp. d/b/a Impex Systems Group

(21) Appl. No.: 10/752,492

(22) Filed: Jan. 8, 2004

(51) Int. Cl. B61B 1/00; B65G 1/00; E04H 3/00

(52) U.S. Cl. 186/52

(57) ABSTRACT

A point of sale apparatus for a coiled garden hose with a predetermined length includes a short coiled garden hose having a length less than the predetermined length. A vertically mounted backing carries (a) a spigot connected to a connector at one end of the short coiled hose, and (b) a holder carrying the short coiled hose. The spigot and holder are positioned to enable a prospective purchaser to see the coiled hose carried by the holder and connected to the spigot.

### FIELD OF INVENTION

The present invention relates generally to a point-of-sale method and apparatus for coiled garden-type hoses and more particularly to such a method and apparatus wherein a connector at one and of a coiled hose of a type similar to that being offered for sale is connected to a spigot located in proximity to a holder for the coiled hose in a retail establishment for selling coiled hoses.

### BACKGROUND ART

Coiled garden hoses, of a type which have recently become popular consumer products, have typically been sold in the same or a similar manner as conventional garden-type hoses. The coiled garden-type hoses being offered for sale at retail establishments are usually located inside stacked boxes at the establishments. Prospective purchasers of the coiled garden-type hoses are unable to appreciate the expansion and recoil properties of the hoses while the hoses are located inside the boxes. Consequently, only a prospective purchaser who is very interested in buying a coiled garden-type hose bothers to open one of the boxes and manipulate the hose in the box to realize the expansion and recoil properties of the coiled hose. Hence, a casual or impulse prospective purchaser of a garden-type hose does not usually go to the trouble of investigating the virtues of a coiled garden-type hose. As a result, casual or impulse prospective purchasers are unlikely to buy coiled garden-type hoses. This is particularly true because of the premium price of coiled garden-type hoses compared to conventional, elongated non-coiled garden-type hoses.

It is, accordingly, an object of the present invention to provide a new and improved point-of-sale method and apparatus for coiled garden-type hoses.

Another object of the invention is to provide a new and improved point-of-sale method and apparatus for coiled garden-type hoses, wherein a prospective purchaser can realize the virtues of a coiled garden-type hose without having to open a container, i.e., box, containing one of the coiled garden-type hoses.

An additional object of the invention is to provide a new and improved point-of-sale method and apparatus for coiled garden-type hoses, wherein a prospective purchaser can realize the expansion and recoil properties of a sample coiled garden-type hose that is similar to the coiled garden-type hose to be purchased.

### SUMMARY OF THE INVENTION

In accordance with one aspect of the present invention a point of sale apparatus for a coiled garden-type hose comprises a backing adapted to be vertically mounted, wherein the backing carries (a) a spigot adapted to be connected to a connector at one end of the coiled hose, and (b) a holder for the coiled hose. The spigot and holder are adapted to be positioned to enable a prospective purchaser to see the coiled hose while the hose is carried by the holder and the coiled hose is connected to the spigot.

Preferably, the holder includes a transparent vertical wall for enabling the prospective purchaser to see the coiled hose through the wall while the hose is carried by the holder.

The holder is preferably mounted directly below and in proximity to the spigot.

An informative poster concerning the coiled hose is preferably mounted in proximity to the spigot and holder in such a position as to enable the prospective purchaser to see the informative poster while viewing the coiled hose connected to the spigot and carried by the holder.

Preferably, at least one container having therein a coiled hose available for sale is located in proximity to the poster, backing, spigot and holder. The coiled hose available for sale has a predetermined length. The predetermined length of the coiled hose in the container and the size of the holder are such that the coiled hose in the container cannot fit into the holder while connected to the spigot. The hose connected to the spigot and in the holder is sufficiently short that it can fit in the holder while connected to the spigot and is sufficiently long to enable the expansion and contraction properties thereof to be realized by a person lifting the hose from the holder.

Preferably, the holder and spigot are mounted at a height for enabling the prospective purchaser, i.e., an adult of average height, to manipulate the spigot and lift the coiled hose connected to the spigot and in the holder.

Another aspect of the invention relates to a method of offering coiled hoses for sale. The method includes the steps of connecting a connector at one end of a coiled hose of a type similar to the coiled hoses being offered for sale to a spigot in a retail establishment selling the coiled hoses. The coiled hose having a connector connected to the spigot in a holder in proximity to the spigot is placed at a height for enabling a typical prospective purchaser to manipulate the spigot and lift the coiled hose connected to the spigot from the holder so the prospective purchaser can realize the expansion and recoil properties of the coiled hose connected to the spigot by lifting the hose connected to the spigot from the holder.

The above and still further objects, features and advantages of the present invention will become apparent upon consideration of the following detailed description of a specific embodiment thereof, especially when taken in conjunction with the accompanying drawings.

### BRIEF DESCRIPTION OF THE DRAWINGS

FIG. 1 is a front view a coiled hose point-of-sale apparatus in accordance with a preferred embodiment of the present invention;

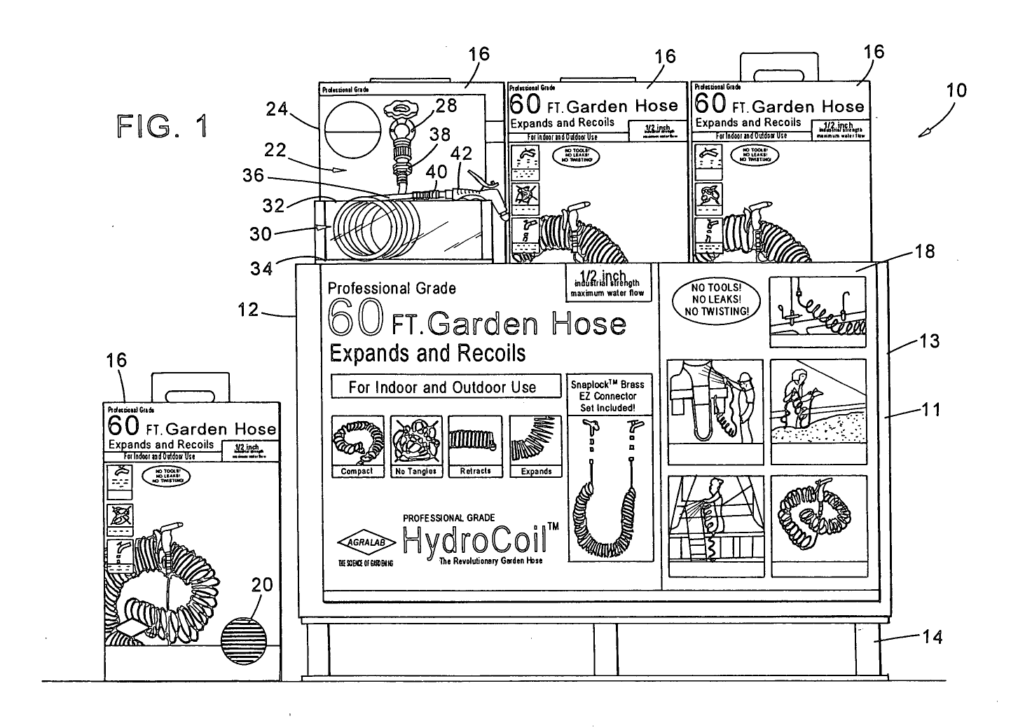

FIG. 2 is a side view of the apparatus illustrated in FIG. 1;

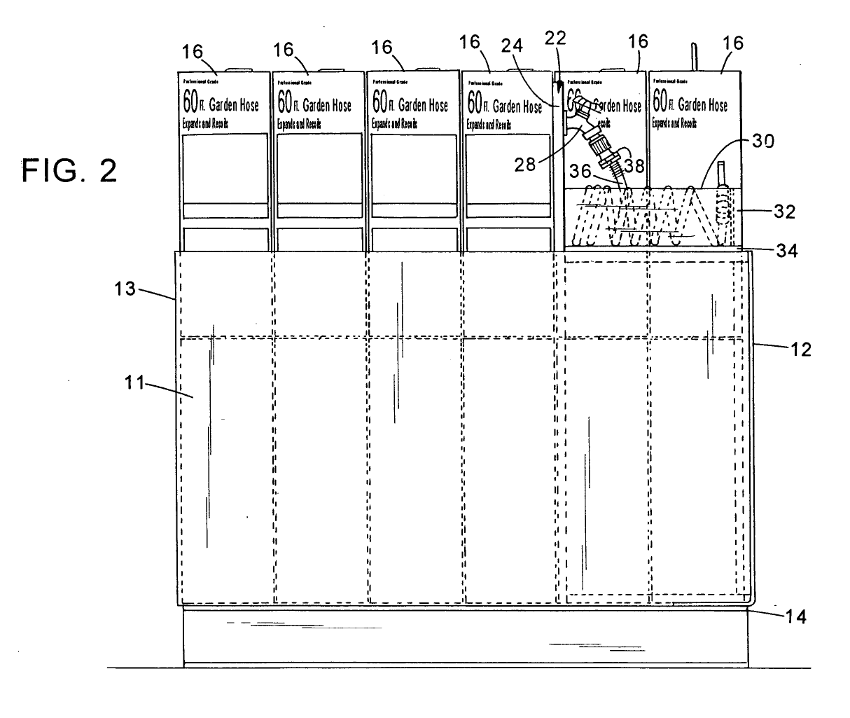

FIG. 3 is an enlarged view of a portion of the apparatus illustrated in FIGS. 1 and 2; and

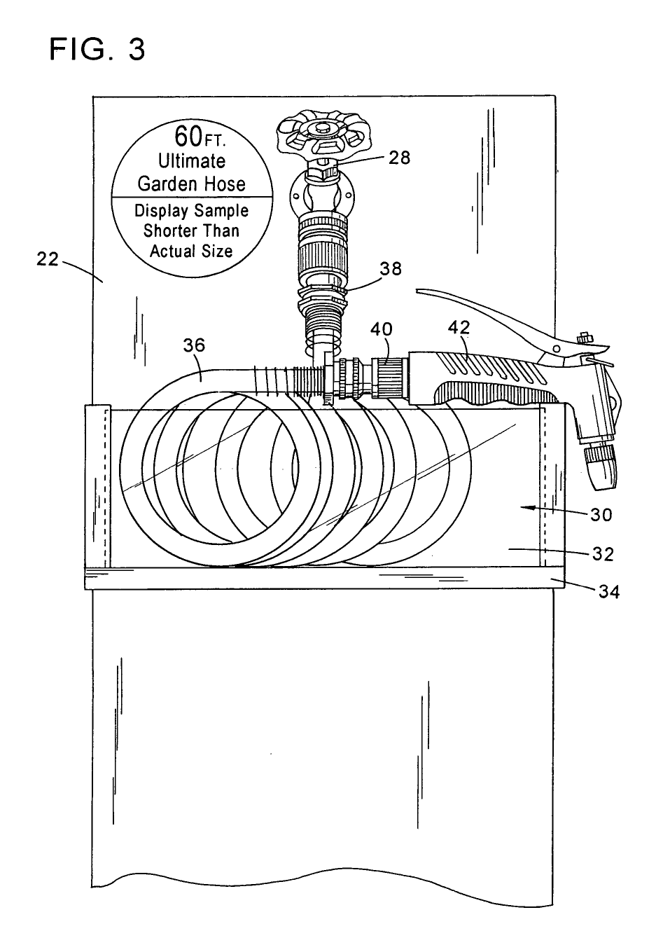

FIG. 4 is a front view, similar to the view of FIG. 1, wherein an adult male is manipulating a coiled hose connected to a spigot and located, under quiescent conditions, in a holder of the point-of-sale apparatus.

### DETAILED DESCRIPTION OF THE DRAWINGS

Reference is now made to the drawings wherein retail store point-of-sale apparatus 10 for a coiled garden-type hose is illustrated as including vertically extending front wall 11 and vertically extending side walls 12 and 13 fixedly mounted on faces of skid (i.e., palette) 14, having a rectangular floor. Typically, walls 11-13 are made of a solid material such as corrugated cardboard.

Numerous boxes 16 are stacked in columns and rows on the rectangular floor of skid 14. In each of boxes 16 is located a coiled garden hose (not shown) having a predetermined length, such as 60 feet, and hardware (not shown) for use with the hose. Each of boxes 16 is shaped as a right parallelepiped. The hardware in each box typically includes a connector (with associated washers) for each end of the hose and a spray nozzle (not shown).

Vertically extending informative poster 18, having information printed thereon about the virtues of the coiled garden hoses and hardware in boxes 16, is fixedly mounted on front wall 11. In one preferred arrangement, the informative information on poster 18 indicates (1) possible uses of the coiled hoses in boxes 16, (2) written and diagrammatic information about the expansion and contraction properties of the coiled hoses in boxes 16, (3) the length and diameter of the coiled garden hoses in boxes 16, and (4) the nature of the connectors and other hardware in boxes 16.

Each of boxes 16 also has printed on the exterior thereof written and pictorial information concerning the virtues of the coiled hose and hardware in the box. In addition, each of boxes 16 includes a window 20 for enabling a prospective purchaser of a coiled garden hose at point-of-sale apparatus 10 to actually see the hose in the boxes. Preferably, one of boxes 16 is mounted on the floor in proximity to skid 14 and at least one, and preferably two columns of boxes 16 extend above the upper edge of poster 18.

Vertically extending backing 22, fixedly mounted on the floor of skid 14, extends in a plane (1) parallel to the plane of front wall 1 1 and poster 18 and (2) at right angles to side walls 12 and 13. Backing 22 is made of a solid material such as molded polystyrene. The height of backing 22 is such that the upper edge of the backing is above the upper edges of wall 12 and poster 18, and is slightly below the upper faces of the highest row of boxes 16 carried by skid 14. Backing 22 has a length parallel to the front face of skid 14 that is approximately one-third of the distance between sidewalls 12 and 13. Vertical edge 24 of backing 22 is approximately aligned with one sidewall 12. The other vertical edge 26 of backing 22, i.e., the edge of backing 22 opposite and parallel to edge 24, is thus spaced from the edge 24 by distance approximately equal to one-third of the distance between sidewalls of skid 14. Backing 22 extends in a plane that is approximately one-third of the distance between the front and back walls of skid 14 so that the backing is closer to the front wall of the skid than to the back wall of the skid. The foregoing position and arrangement of backing 22, the size of skid 14, the size of boxes 16, and the typical position of boxes 16 on skid 14 are such that for a typical fully loaded skid 14, two columns of boxes 16 are located between edge 26 and wall 13; these two columns are six columns deep between the front and back faces of skid 14. In addition, one column of boxes 16 is located behind backing 22; the column of boxes behind backing 22 is four columns deep between the backing and and the back face of skid 14. Typically, each of the columns of boxes 16 is at least two boxes high.

Garden hose spigot 28 is fixedly mounted on the face of backing 22 parallel to and facing poster 18 so the spigot is slightly below the upper edge of the backing. Thereby, the spigot is at a height for enabling an adult of average height to manipulate the spigot and is visible to a prospective purchaser who is approaching the front wall 11 of point-of-sale apparatus 10 where poster 18 is mounted. Backing 22 also fixedly carries coiled hose holder 30, shaped as a right parallelepiped.

Coiled hose holder 30 is fixedly mounted (1) on the same face of backing 22 as spigot 28 and (2) in proximity to spigot 28, slightly and directly below the spigot outlet. Coil hose holder 30 has a transparent vertical wall 32, made of PLEXIGLAS for example. Transparent vertical wall (i.e. front face) 32 is located in substantially the same vertical plane as front wall 11 and poster 18 so wall 32 is completely above the upper edge of poster 18, by virtue of the floor 34 of holder 30 resting on the upper edge of wall 11. Thereby, spigot 28 and the interior of coiled hose holder 30 are visible to a prospective purchaser who is approaching wall 1 1 of point-of-sale apparatus 10 where poster 18 is mounted. Coiled hose holder 30 has an open top and sufficient volume between backing 22 and wall 32 and between the side walls of the holder that are aligned with the side edges of the backing to hold a coiled hose having (1) a length of sufficiently great to enable a prospective purchaser to manipulate the coiled hose and discover the virtues of the coiled hose, but a length substantially less than the length of the coiled hoses in boxes 16 and and (2) the same diameter as the coiled hoses in boxes 16. Holder 30, however, does not have sufficient volume to enable the full-size coiled hoses in boxes 16 to fit in the holder. A prospective purchaser is able to appreciate the expansion and contraction virtues of the coiled hoses in boxes 16 if the coiled hose in holder 30 has a length of, for example, approximately 15 feet.

Holder 30 carries coiled garden hose 36, having a length substantially less than the length of the coiled hoses in boxes 16 and the same diameter as the coiled hoses in boxes 16. Typically, hose 36 has a length of about 15 feet and is positioned in holder 30 so that opposite ends of hose 36 are located above the open top of holder 30. Opposite ends of coiled hose 36 has conventional garden hose connectors 38 and 40 fixedly mounted thereon. Connector 38 is connected to the outlet of spigot 28 in the usual manner, while connector 40 is connected to spray attachment 42, one of the pieces of hardware typically included, along with the connectors, in each of boxes 16.

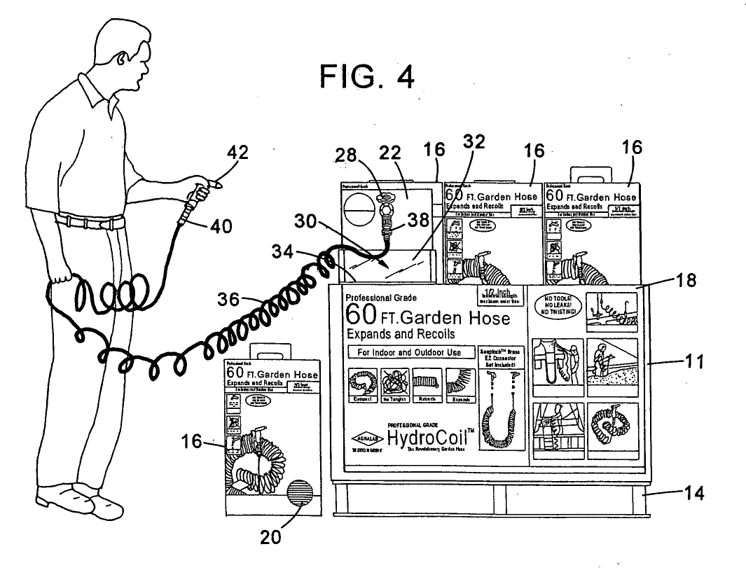

A prospective purchaser, frequently an impulse buyer, approaching the retail store point-of-sale apparatus 10 is attracted to the point-of-sale apparatus by the clearly visible coiled hose 36 in holder 30 and by poster 18. As illustrated in FIG. 4, such a prospective purchaser is able easily to lift coiled hose 36 through the open top of holder 30 and manipulate the coiled hose because the holder and spigot 28 are at a convenient height for an average adult. The prospective purchaser realizes the expansion and contraction properties of coiled hose 36 in holder 30 by picking up and manipulating the coiled hose. Such a purchaser is induced to pick up and manipulate coiled hose 36 by the reading availability and visual impact of the hose in holder 30 and the connection of the hose to spigot 28, as well as by the visual impact of poster 18. In retail establishments where point of sale apparatus 10 has been used, there has been a substantial . . . ????? The substantial increase in sales occurred without any other changes in sales techniques.

While there has been described and illustrated a specific embodiment of the invention, it will be clear that variations in the details of the embodiment specifically illustrated and described may be made without departing from the true spirit and scope of the invention as defined in the appended claims.

1. A point of sale apparatus for a coiled garden-type hose comprising a backing adapted to be vertically mounted, the backing carrying (a) a spigot adapted to be connected to a connector at one end of the coiled hose, and (b) a holder for the coiled hose, the spigot and holder being adapted to be positioned to enable a prospective purchaser to see the coiled hose while the hose is carried by the holder and the coiled hose is connected to the spigot.

2. The apparatus of claim 1 wherein the holder includes a transparent vertical wall for enabling the prospective purchaser to see the coiled hose through the wall while the hose is carried by the holder.

3. The apparatus of claim 2 wherein the holder is mounted in proximity to the spigot.

4. The apparatus of claim 2 wherein the holder is mounted directly below and in proximity to the spigot.

5. The apparatus of claim 4 further including an informative poster concerning the coiled hose mounted in proximity to the spigot and holder in such a position as to enable the prospective purchaser to see the informative poster while viewing the coiled hose as the coiled hose is connected to the spigot and carried by the holder.

6. The apparatus of claim 1 wherein the holder is mounted directly below and in proximity to the spigot.

7. The apparatus of claim 6 further including an informative poster concerning the coiled hose mounted in proximity to the spigot and holder in such a position as to enable the prospective purchaser to see the informative poster while viewing the coiled hose as the coiled hose is connected to the spigot and carried by the holder.

8. The apparatus of claim 1 further including an informative poster concerning the coiled hose mounted in proximity to the spigot and holder, the poster being in a position for enabling the prospective purchaser to see the informative poster while viewing the coiled hose as the coiled hose is connected to the spigot and carried by the holder.

9. A point of sale apparatus comprising a coiled garden-type hose, a vertically mounted backing, the backing carrying (a) a spigot connected to a connector at one end of the coiled hose, and (b) a holder carrying the coiled hose, the spigot and holder being positioned to enable the prospective purchaser to see the coiled hose carried by the holder and connected to the spigot.

10. The apparatus of claim 9 wherein the holder includes a transparent vertical wall for enabling the prospective purchaser to see the coiled hose carried by the holder through the wall.

11. The apparatus of claim 10 wherein the holder is mounted directly below and in proximity to the spigot.

12. The apparatus of claim 11 further including an informative poster concerning the coiled hose mounted in proximity to the spigot and holder in such a position as to enable the prospective purchaser to see the informative poster while viewing the coiled hose as the coiled hose is connected to the spigot and carried by the holder.

13. The apparatus of claim 12 further including at least one container having therein a coiled hose available for sale; the coiled hose available for sale having a predetermined length; the container being located in proximity to the poster, backing, spigot and holder; the predetermined length of the coiled hose in the container and the size of the holder being such that the coiled hose in the container cannot fit into the holder while connected to the spigot; the hose connected to the spigot and in the holder being sufficiently short that it can fit in the holder while connected to the spigot.

14. The apparatus of claim 9 further including at least one container having therein a coiled hose available for sale; the coiled hose available for sale having a predetermined length; the container being located in proximity to the backing, spigot and holder; the predetermined length of the coiled hose in the container and the size of the holder being such that the coiled hose in the container cannot fit into the holder while connected to the spigot; the hose connected to the spigot and in the holder being sufficiently short that the hose connected to the spigot can fit in the holder, the hose connected to the spigot being sufficiently long to enable the expansion properties thereof to be realized by a person lifting the hose connected to the spigot from the holder.

15. The apparatus of claim 14 wherein the holder includes a transparent vertical wall for enabling the prospective purchaser to see the coiled hose carried by the holder through the wall.

16. The apparatus of claim 15 wherein the holder is mounted directly below and in proximity to the spigot.

17. The apparatus of claim 16 wherein the holder and spigot are mounted at a height for enabling the prospective purchaser to manipulate the spigot and lift the coiled hose connected to the spigot and in the holder.

18. A method of offering coiled hoses for sale comprising the steps of connecting a connector at one end of a coiled hose of a type similar to the coiled hoses being offered for sale to a spigot in a retail establishment selling the coiled hoses, and placing the coiled hose having a connector connected to the spigot in a holder in proximity to the spigot at a height for enabling a prospective purchaser to manipulate the spigot and lift the coiled hose connected to the spigot from the holder to enable the expansion properties of the coiled hose connected to the spigot to be realized by the prospective purchaser lifting the hose connected to the spigot from the holder.

19. The method of claim 18 wherein at least one container having therein a coiled hose available for sale is located in proximity to the spigot and holder; the coiled hose available for sale having a predetermined length; the predetermined length of the coiled hose in the container and the size of the holder being such that the coiled hose in the container cannot fit into the holder while connected to the spigot; the hose connected to the spigot and in the holder being sufficiently short that the hose connected to the spigot can fit in the holder; the hose connected to the spigot being sufficiently long to enable the expansion properties thereof to be realized by the prospective purchaser lifting the hose connected to the spigot from the holder; the method further comprising the step of causing the prospective purchaser of a coiled hose having the predetermined length to realize the expansion and contraction properties of the coiled hose having the predetermined length by inducing the prospective purchaser to manipulate the coiled hose in the holder to cause the coiled hose in the holder to expand and recoil.
